(19) United States
(12) Patent Application Publication
(10) Pub. No.: US 2009/0200707 A1
(43) Pub. Date: Aug. 13, 2009

(54) METHOD OF FABRICATING GRAPHENE STRUCTURES ON SUBSTRATES

(75) Inventors: Jani KIVIOJA, Espoo (FI); Tomi Haatainen, Espoo (FI); Jouni Ahopelto, Espoo (FI)

Correspondence Address: BIRCH STEWART KOLASCH & BIRCH, PO BOX 747, FALLS CHURCH, VA, 22040-0747, US

(73) Assignee: Valtion Teknillinen Tutkimuskeskus, Espoo (FI)

(21) Appl. No.: 12/367,353

(22) Filed: Feb. 6, 2009

(30) Foreign Application Priority Data
Feb. 8, 2008 (FI) 20085113

(51) Int. Cl. B29C 59/02

(52) U.S. Cl. 264/293; 425/470

(57) ABSTRACT

The present invention relates to fabrication of graphene structures having a predefined pattern. The invention provides a new method that comprises obtaining a body of highly oriented graphite (61) and patterning at least a surface layer of the body by removing the substance of the body outside the predefined pattern. Thereafter, the method comprises stamping a graphene structure (65) on the substrate (62) by pressing the patterned surface layer of the body (61) against the substrate (62). The invention provides also a stamp for the fabrication method.

### TECHNICAL FIELD

The present invention relates to a method of fabricating a graphene structure having a predefined pattern. The graphene structure is fabricated on a substrate and preferably has a predefined location on the surface of the substrate.

The present invention relates also to apparatuses and means for the fabrication method.

### BACKGROUND ART

There has been a growing interest in the field of carbon-based electronics during recent years. For instance, carbon nanotubes have been suggested for field-effect-transistor and also for biosensor building blocks. Besides nanotubes, carbon has several other crystal forms like diamond, graphite and fullerene as well. Graphite, the carbon in our pencils, consists of a stack of carbon, namely graphene, sheets. FIG. 1 illustrates a crystal structure of graphite. 2D hexagonal honeycomb structure of individual graphene layers is presented in FIG. 2.

Despite that the graphene was for the first time isolated only few years ago (by using ordinary Scotch tape), this field is nowadays relatively intensively studied. The reason is that this material has unique electrical properties, e.g. high charge carrier mobility etc., which are ultimately promising for electronic applications. For example, graphene transistor has been demonstrated recently and more advanced graphene circuits are proposed to be promising candidate, e.g., to replace silicon in future IC-technology. However, the lack of easy and low cost graphene fabrication process strongly limits the development of graphene applications.

Present IC-technology fabrication processes are using large silicon wafers (diameter >200 mm), which yield that the mass production of commercial graphene circuits would require high quality graphene on large area. However, the first graphene fabrication techniques could provide only very small pieces of single crystal graphene.

WO 2007/097928 A1 discloses graphene layers epitaxially grown on single crystal substrates. A produced device comprises a single crystal region that is substantially lattice-matched to graphene. A graphene layer is deposited on the lattice-matched region by means of molecular beam epitaxy (MBE), for instance.

In view of a possible mass production of graphene devices, the method disclosed in the WO publication is disadvantageous in that it requires the use of MBE, which method is relatively slow and expensive to use.

A publication by Xiaogan Liang, Zengli Fu, and Stephen Y. Chou, “Graphene Transistors Fabricated via Transfer-Printing in Device Active-Areas on Large Wafer”, (Nano Lett., 7 (12), 3840-3844, 2007, Web Release Date: Nov. 14, 2007), discloses another approach to graphene structure fabrication. The disclosed method comprises using a stamp with protrusions such that the stamp is pressed against a graphite substrate to cut a piece of graphene out of the graphite substrate. The piece of graphene attaches to the surface of the stamp and follows the stamp when lifted. After this, the graphene sheet attached to the stamp is inspected and transferred on to a target area on another substrate.

In view of a possible mass production of graphene devices, also the method disclosed in the above-mentioned publication has potential disadvantages. For example, it is assumed that formation of the patterns by mechanical stamping process, which relies on cutting and attachment of the graphene layers, would be unreliable in producing high-precision patterns, for example very sharp and narrow or closely spaced features. To alleviate this inherent problem in the method, the publication discloses the inspection step, but in view of a possible mass production, the required inspection and re-stamping load would probably be excessive when producing high-precision patterns.

None of the so far disclosed methods has demonstrated good performance for actual production purposes, and therefore there is a need to find new alternatives in the way towards mass production of electronic devices comprising graphene patterns.

### DISCLOSURE OF INVENTION

It is an object of the present invention to provide a new method for fabricating a graphene structure having a predefined pattern.

According to an aspect of the invention, there is provided a new method that comprises obtaining a body of highly oriented graphite and patterning at least a surface layer of the body by removing the substance of the body outside the predefined pattern. Thereafter, the method comprises stamping a graphene structure on the substrate by pressing the patterned surface layer of the body against the substrate.

According to another aspect of the invention, there is provided a method of fabricating a graphene structure having a predefined pattern, the method comprising first providing a layer of highly oriented graphite having the predefined pattern and then pressing said layer with the predefined pattern against a substrate and thereby stamping the graphene structure having the predefined pattern on the substrate.

Therefore, the invention provides a new method for fabricating graphene structures having predefined patterns.

It is believed that the new method provides an attractive alternative to the existing methods described above.

The method has several embodiments that have potentially advantageous features.

In an embodiment based on stamping procedure, there is no need to use epitaxial methods, such as MBE, CVD, thermal decomposition of SiC or other related methods.

In an embodiment using lithography in patterning the surface layer of the graphite body, the pattern is defined directly by lithography. Therefore, the graphene patterns can be manufacture more accurately than in the above-mentioned method by Xiaogan Liang et al. Furthermore, the use of lithography makes it possible to pattern a considerably thicker layer of graphite body than is possible by the stamping method by Xiaogan Liang et al.

Accurate patterns can be produced also in an embodiment using laser beam to pattern the surface layer of the graphite body. Also in this embodiment, the graphene patterns can be manufacture more accurately and as a thicker layer than in the method of Xiaogan Liang et al.

Ultimately small patterns can be made in an embodiment using focused ion beam (FIB) to mill the surface layer of the graphite body.

In an embodiment, wherein the patterned surface layer of the graphite body is relatively thick, a single stamp can produce numerous graphene structures on the substrate. In the method of Xiaogan Liang et al. the patterned layer on the stamp comprises only few layers of graphene whereas some embodiments of the present method can provide stamps that are practically endless. A thick layer of identically patterned layers of graphene, which is achieved by these embodiments, is useful when fabricating several identical patterns of graphene on a substrate or several substrates.

In an embodiment, wherein the surface layer of the graphite body is patterned by removing the substance of the body outside the predefined pattern, the layers of graphene in the stamp remain intact. In other words, the layers to be stamped form part of the original body of highly oriented graphite even at the moment of contact with the target substrate. Therefore, this embodiment alleviates any possible problems in transferring the layers of graphene from the graphite body to the surface of the stamp that may arise in the method disclosed by Xiaogan Liang et al.

In the method of Xiaogan Liang et al. the patterning of the layers of graphene is effected by mechanical cutting forces applied by means of the stamp. In addition to the mechanical cutting, the attachment of the layers onto the surface of the stamp determine the quality of the graphene patterns. The present invention provides embodiments that are capable of avoiding any possible irregularities caused by cutting by stamp. This is because the patterns can be made by patterning the source graphite body itself by means of etching or laser, for instance.

Embodiments also allow the fabricated patterns to be very accurately aligned with regard to the substrate. Therefore, the embodiments can be used to fabricate graphene structures accurately placed on top of prefabricated functional features, such as resistors, electrodes, wave-guides etc.

The present invention has also embodiments wherein the fabrication process is more straightforward that prior art methods. There is no need for MBE, for instance. Neither is the method complicated by the need of repeating phases of cutting by stamp, inspection and stamping on the substrate.

According to another aspect of the invention, there is provided a stamp for the aforesaid method. Such a stamp comprises comprising a plurality of graphene layers on top of each other and parallel to an outer surface of the stamp, wherein said plurality comprises at least 30 layers and each layer in said plurality reproduces an identical stamping pattern.

In an embodiment, such a stamp has relatively high number of patterned graphene layers on top of each other whereby the stamp can be used repeatedly to produce an identical stamping pattern on substrates.

### BRIEF DESCRIPTION OF DRAWINGS

For a more complete understanding of the present invention and the advantages thereof, the invention is now described with the aid of the examples and with reference to the following drawings, in which:

FIG. 1 shows the structure of a graphite crystal;

FIG. 2 shows the crystal structure of a single layer graphene;

FIGS. 3A-3C depict a graphene structure fabrication method according to an embodiment of the invention;

FIGS. 4A-4H depict a graphene stamp fabrication method according to an embodiment of the invention;

FIGS. 5A and 5B depict a detail of the stamping step according to an embodiment of the invention; and

FIGS. 6A-6C depict a graphene structure fabrication method according to another embodiment of the invention.

### BEST MODE FOR CARRYING OUT THE INVENTION

The following embodiments describe fabrication of predetermined graphene structures on substrate surfaces by transferring patterned graphene sheets to the desired position by means of imprinting with graphite stamp.

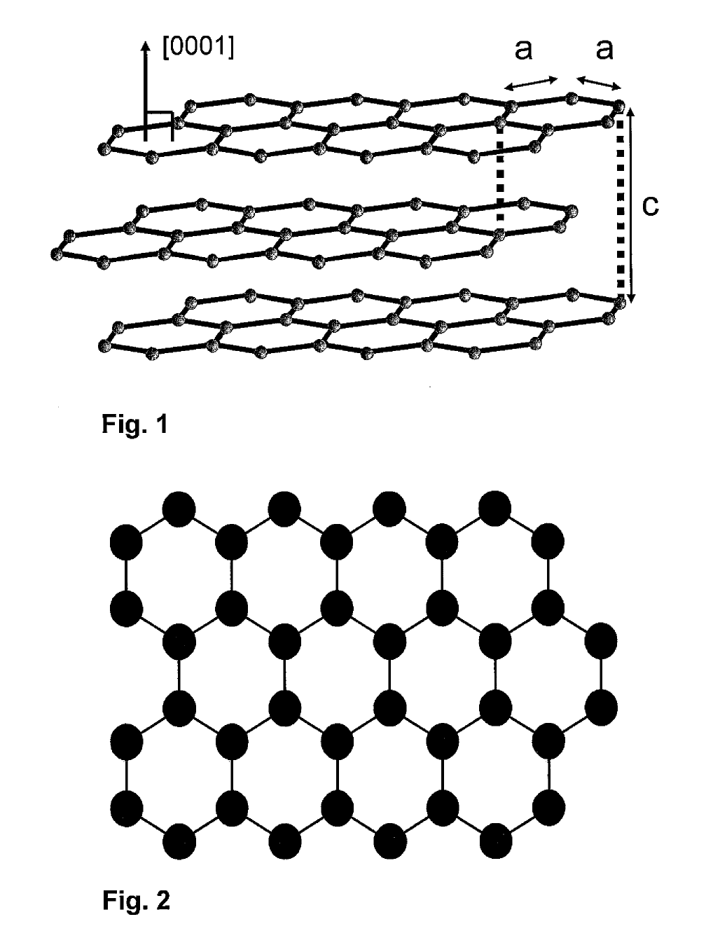

FIG. 1 shows the structure of a graphite crystal. The graphite primitive lattice constants are a=2.46 Å (=0.246 nm) and c=6.7 Å (=0.67 nm). A denotes Angstrom, which is equal to 0.1 nm (nanometre). A surface to the crystal to be patterned as the stamp is (0001)-oriented with high accuracy.

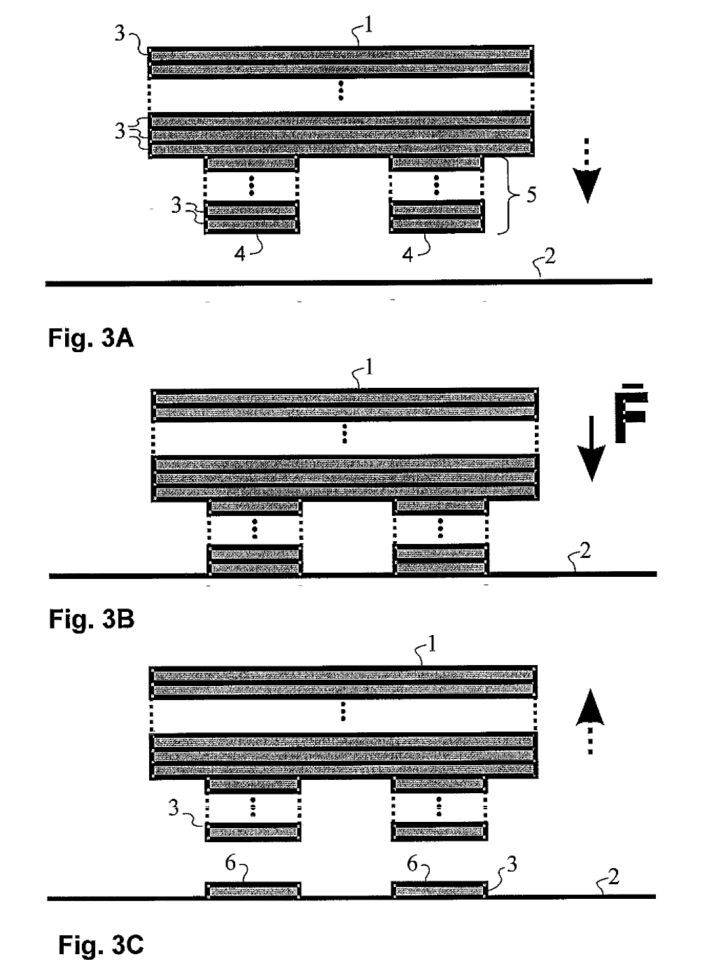

FIG. 2 shows the crystal structure of a single layer graphene. The graphene layer is one individual layer of graphite.

In general, the embodiments can be used to fabricate predetermined graphene structures on target substrate wafer by transferring patterned graphene sheets to the desired position by pressing the target surface with graphite stamp. Under the large enough pressure the bottom most graphene layer(s) are layer bonded to target surface if certain conditions are fulfilled. Therefore, when the graphite stamp and the target surface are separated again, few or single bottom layers of the graphite stamps are transferred to the target surface and thus form detached graphene structures. With step-and-stamp approach the same patterned graphene structure can be transferred to target substrate surface many times. For practical purposes, the same stamp can be used thousands of times. If the height of the etched structures in the stamp is, e.g. 1 μM (micrometre), the amount of patterned graphene layers is approximately 3000.

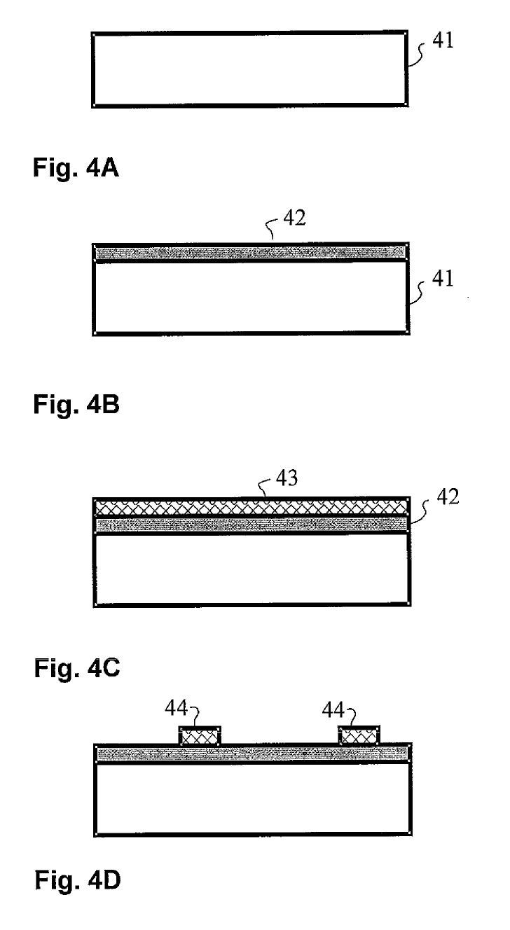

The graphene structure fabrication method of the embodiment includes the process steps of approaching, layer bonding and separation. This is shown in FIGS. 3A-3C.

In FIG. 3A, the graphite stamp 1 is approaching the target surface 2. The graphite stamp 1 comprises several graphene layers 3 on top of each other. These graphene layers 3 are parallel to the outer surface 4 of the stamp 1. The stamp 1 has a patterned surface layer 5, which comprises several graphene layers 3 reproducing an identical stamping pattern.

FIG. 3B shows the layer bonding step. During this step, the graphite stamp 1 is pressed against substrate target surface 2. In FIG. 3C, the graphite stamp 1 is extracted from the target surface 2 in such a way that a single or few graphene layers 3 are separated from the stamp and layer bonded to the target substrate. These layers 3 form the produced predefined graphene patterns 6.

In the embodiment of FIGS. 3A-3C, the base material of the stamp 1 is high quality graphite with low impurity levels and with large lateral grain size. The maximum impurity level requirement depends on application purpose, but e.g. for electrical purposes usually impurity levels less than 10 ppm are requires to ensure high charge carrier mobility. The minimum lateral grain size is preferably larger than the maximum dimensions of the desired graphene structure. Typically high quality and highly ordered graphite crystal have lateral grain size in between 3 mm up to 10 mm.

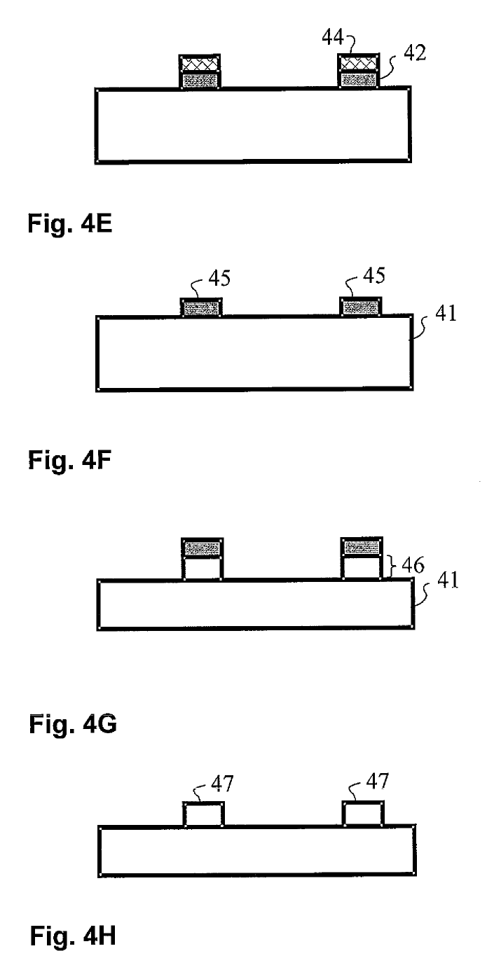

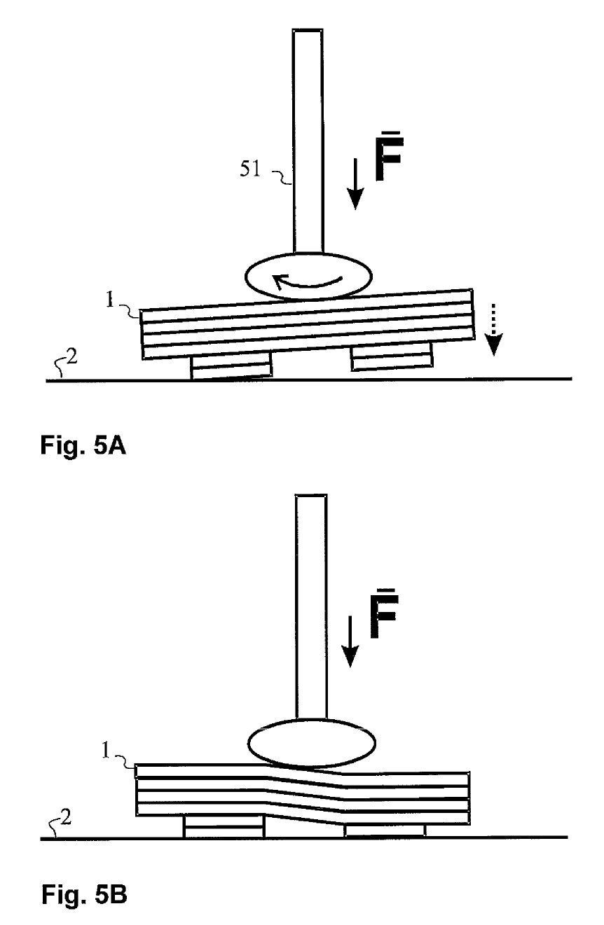

The crystal structure of the base material graphite is highly orientated along base material surfaces 4. The crystal orientation of the stamp 1 is (0001)-oriented in perpendicular to patterned stamp surface 4 with perfect accuracy. This means that the individual graphene flakes of the graphite crystal are orientated along the patterned stamp surface 4 within atomic accuracy and thus patterned stamp surface 4 is (0001)-oriented with high accuracy. Further, within each individual structure of the stamp 1, the graphite surface is atomically flat. Individual structure means here one closed transferred element 6. Between different structures 6, the possible deformation of the stamp 1 due to stamping pressure allows small height variations of the stamp 1 of graphite base material surface (see FIG. 5). Thus, the surface roughness requirements of the base graphite material depend on the desired stamp structure and the stamping pressure. For example highly orientated pyrolytic graphite provided by Structure Probe Inc (Grade SP-1) is demonstrated to meet the stamp requirements. The stamp can be fabricated by traditional lithographical and etching methods, for example, by using photo or e-beam lithography with oxygen plasma etching. An embodiment of a graphite stamp fabrication method is presented in FIGS. 4A-4H.

FIG. 4A shows the base material of the stamp fabrication. The base material is a body 41 of highly oriented graphite. The dimensions of the dice are 10 mm×10 mm×2 mm, for instance.

As shown in FIG. 4B, a thin SiO₂ layer 42 is deposited on top the body 41 The thickness of the SiO₂ layer 42 is 200 nm, for instance. Next, the dice is spin coated with photoresist to form a photoresist layer 43. This is shown in FIG. 4C. Then the photoresist layer 43 is patterned by UV-lithography and developed to form a photoresist mask 44 shown in FIG. 4D. The mask 44 is an image of the desired graphene patterns to be fabricated later.

As shown in FIG. 4E, the SiO₂ layer 42 is etched to copy the pattern of the photoresist mask 44. This can be done by wet etching in 5% HF solution, for instance. Next, the photoresist layer 44 is removed. The result is the body 41 of highly oriented graphite with SiO₂ mask 45 on its main surface. The mask 45 is an image of the desired patterns. This is shown in FIG. 4F. Then, the pattern of the SiO₂ mask 45 is transferred to graphite dice by oxygen plasma etching through the SiO₂ mask 45. As a result, the surface layer 46 of the graphite body 41 reproduces the desired patterns as shown in FIG. 4G. The SiO₂ mask 45 is stripped, for example by wet etching in 5% HF solution, and the stamp is ready. FIG. 4H shows the ready stamp with patterned graphene layers 47 on its surface.

Referring back to FIGS. 3A-3C, some properties of the target surface 2 are now discussed in further detail. The target surface 2 needs to have suitable adhesion to graphene layers 3. For example, a clean surface of silicon dioxide can be used as a target surface 2. The target surface 2 can also be treated or coated to enhance adhesion, if necessary. Alternatively or in addition, it is possible to increase the temperature of the target surface 2 to improve surface adhesion and graphene layer 3 bonding to the target surface 2. However, in case of silicon dioxide target surface, for instance, room temperature has been demonstrated to provide good enough adhesion, A further property of the target surface 2 is surface roughness. The surface roughness should be small enough so that deformation of the stamp 1 is capable to compensate any surface height variations. The roughness of thermally oxidized standard silicon wafers has been demonstrated to be small enough.

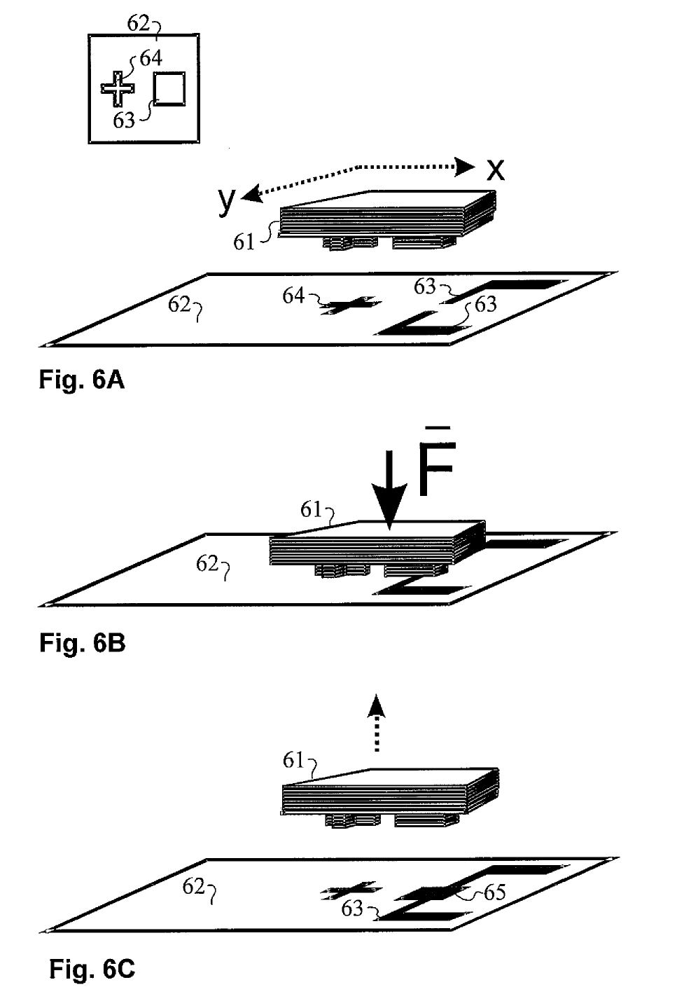

In the embodiment of FIGS. 3A-3C, the steps of the graphene sheet transferring process are performed with Suss MicroTech NPS300 NanoImprinting device. The first step, i.e. the approaching step includes also aligning and orienting the graphite stamp I and the target surface 2 in order to correctly locate the graphene patterns 6 within the target surface 2. If the target surface 2 is prefunctionalized, i.e. it already contains patterned structure or structures, the graphite stamp 1 can be aligned with the target surface structures as shown in FIG. 6A.

In the embodiment of FIG. 6A, the stamp 61 is aligned with a prefunctionalized surface 62 containing functional features 63 and alignment marks 64. The alignment accuracy depends on the used aligned method. For example by using nanoimprinting lithography, it is possible to achieve accuracy as high as 20 nm. As shown in FIGS. 6A-6C, graphene patterns 65 can be bonded in desired positions, e.g. on top of functional features 63 on the target surface 62. The functional features 63 can, for example, gate electrodes or electrical contacts.

The alignment accuracy is given by the used alignment method, but usually with nanoimprinting lithography the alignment accuracy is better than 100 nm. Also the graphite stamp surface 4 is orientated along the target surface 2 with high accuracy (see FIG. 5). Actually, atomical accuracy is desired when using maximum bonding pressure, but during the approaching phase of the stamp 1 and target surface 2, small disorientation is allowed, particularly if deformation of the target wafer and/or the stamp 1 can correct this. It is also possible to use a pressing tool having a flexible holder for the graphite stamp 1 to correct small disorientation of the surfaces 4 and 2. FIG. 5A presents such a pressing tool 51 with flexible arm. As shown in FIG. 5B, also small long-range height steps on the stamp surface can by compensated by allowing a small deformation of the stamp. However, within one stamped structure, the stamp surface should be atomically flat.

The nano imprinting system used in the embodiment has an approaching orientation accuracy better than 20 μrad (microradian) and the flexible stamping head that can correct disorientations up to at least 20 μrad with the pressing force F̅ larger than 1 N (newton).

During the step of bonding the graphite stamp 1 and the target surface 2 together, the stamping pressure induced by the pressing force F̅ is preferably large enough to ensure good contact between the surfaces 4 and 2. Additionally, the pressure is preferably also large enough to produce sufficient deformation to compensate possible disorientation and also possible roughness of the surfaces (see FIG. 5B). However, the pressure should not exceed the compressive strength of the graphite, which is approximately 100 MPa (megapascal). At least the pressures between 1 MPa to 10 MPa have been demonstrated to produce good results. The bonding force F̅ is aligned perpendicular to the bonded surface with high accuracy. With the above-referred device, the accuracy is better than 20 μrad. The high accuracy is necessary because the extremely small friction between graphene layers can cause slipping between layers, which can destroy the desired structure. The increasing of temperature during the layer-bonding step can also be used to improve graphene adhesion to target surface, but with SiO₂ surface, the room temperature is demonstrated to provide large enough adhesion as described above.

The next step is to separate graphite stamp 1 and the target surface 2 in such a way that the bottom most graphene layer(s) 3 remain bonded to target surface 2. To ensure this, the separating force is aligned perpendicular to the bonded surfaces (see FIG. 3C). The above-mentioned device provides a separation force that is orientated with accuracy better than 20 μrad.

Thus, it is possible to perform a method of fabricating a graphene structure 6 having a predefined pattern. The predefined pattern can be designed according to the need of the application. The method comprises
obtaining a body 41 of highly oriented graphite,
patterning at least a surface layer 5, 46 of the body 41 by removing the substance of the body outside the predefined pattern 47, and
pressing the patterned surface layer 5, 46 of the body against a substrate 2, 62 and thereby stamping the graphene structure 6, 65 on the substrate 2, 62.

In an embodiment, the thickness of the patterned surface layer 5, 46 is at least 10 nm, and preferably at least 100 nm, for example more than 1 micrometre. In that case the stamp can produce numerous identical patterns formed by a single or few patterned layers 3 of graphene having the form of the predefined pattern. These graphene layers 3 in the surface layer 5, 46 are parallel and have the orientation of the outer surface 4 of the surface layer 5, 46.

In an embodiment of the method, several identical graphene structures 6, 65 are stamped on the single substrate 2, 62 using the single patterned surface layer 5, 46 of the body. Each of the identical graphene structures 6, 65 can include several distinct features having individually designed shapes, i.e. they may be mutually identical or differing. The same stamp can also be pressed several times against a single substrate on different locations. It is also possible to use a single patterned graphite body 1, 61 to stamp identical graphene structures 6, 65 on a plurality of substrates.

In an embodiment, the patterned surface layer 5, 46 of the body is pressed against the substrate 2, 62 with a pressure of at least 0.1 MPa, preferably between 1 MPa to 100 MPa, such as 2 to 10 MPa.

In an embodiment, the surface of the substrate against which the graphene structure is pressed is hydrophilic.

In an embodiment, the stamp 1, 61 for stamping the graphene structures comprises a plurality of graphene layers 3 on top of each other and parallel to an outer surface 4 of the stamp. In an embodiment, the number of the graphene layers 3 is at least 30 and each of the layers reproduces an identical predefined stamping pattern. In addition to these patterned graphene layers 3, the stamp can of course comprise a body of non-patterned graphene layers 3. In an embodiment the thickness of the patterned layer 5, 46 is at least 10 nm, and preferably at least 100 nm, for example more than 1 micrometre.

In embodiments, the stamping pattern can comprise features of differing shapes and also with very narrow dimensions. Minimum dimensions can be under 20 nm, even under 10 nm, and also the minimum pitch between the distinct features of the stamping pattern can be less than 20 nm, even under 10 nm. However, the diameter of the whole stamping pattern can be greater than 1 micrometre, for example greater than 1 millimetre. Therefore it is apparent, that the stamped graphene features can be also long and narrow and have very different shapes according to the application.

The above description is only to exemplify the invention and is not intended to limit the scope of protection offered by the claims. The claims are also intended to cover the equivalents thereof and not to be construed literally.

1. A method of fabricating a graphene structure having a predefined pattern, the method comprising
providing a layer of highly oriented graphite having the predefined pattern, and
pressing the layer of highly oriented graphite having the predefined pattern against a substrate and thereby stamping the graphene structure having the predefined pattern on the substrate.

2. A method of fabricating a graphene structure having a predefined pattern, the method comprising
obtaining a body of highly oriented graphite,
patterning at least a surface layer of the body by removing the substance of the body outside the predefined pattern, and
pressing the patterned surface layer of the body against a substrate and thereby stamping the graphene structure on the substrate.

3. The method of claim 2, wherein the thickness of the patterned surface layer of the body is at least 10 nm, and preferably at least 100 nm, for example more than 1 micrometre.

4. The method of claim 2, wherein the patterned surface layer of the body comprises graphene layers such that each of the layers has the form of the predefined pattern.

5. The method to any of claim 2, wherein at least the surface layer of the body consists of parallel graphene layers having the orientation of the outer surface of the surface layer.

6. The method of claim 4, comprising stamping several identical graphene structures on the single substrate using the single patterned surface layer of the body.

7. The method of claim 4, comprising taking a plurality of substrates and using the single patterned graphite body to stamp identical graphene structures on the plurality of substrates.

8. The method of claims 2, wherein the patterned surface layer of the body is pressed against the substrate with a pressure of at least 0.1 MPa, preferably between 1 MPa to 100 MPa, such as 2 to 10 MPa.

9. The method of claim 2, wherein the graphene structure is pressed against a hydrophilic surface of the substrate.

10. The method of claim 2, wherein the substrate includes a planar surface, and the method comprises pressing the patterned surface layer of the body against the planar surface of the substrate and thereby stamping the graphene structure on the planar surface of the substrate.

11. The method of claim 10, wherein the step of pressing and stamping includes moving the patterned surface layer of the body exclusively in a direction perpendicular to the planar surface of the substrate and thereby preventing a sliding motion between said body and said substrate and thereby also preventing slipping between the graphene layers in the graphite body.

12. The method of claim 11, comprising aligning the patterned surface layer of the body with regard to the substrate by moving the body parallel tb the planar surface of the substrate prior the step of pressing and stamping.

13. The method of claim 2, wherein the patterned surface layer of the body is planar, and the step of pressing and stamping includes moving the patterned surface layer of the body exclusively in a direction perpendicular to the plane of said patterned surface layer and thereby preventing a sliding motion between said body and said substrate and thereby also preventing slipping between the graphene layers in the graphite body.

14. The method of claim 13, comprising aligning the patterned surface layer of the body with regard to the substrate by moving the body parallel to the plane of said patterned surface layer prior the step of pressing and stamping.

15. A stamp for stamping graphene structures on a substrate, the stamp comprising a plurality of graphene layers on top of each other and parallel to an outer surface of the stamp, wherein said plurality comprises at least 30 layers and each layer in said plurality reproduces an identical stamping pattern.

16. A stamp of claim 15, comprising a highly oriented graphite body having a patterned surface layer, wherein the patterned surface layer is formed by said plurality of graphene layers.

17. The stamp of claim 16, wherein the thickness of the patterned surface layer is at least 10 nm, and preferably at least 100 nm, for example more than 1 micrometre.

18. The stamp of claim 15, wherein the stamping pattern comprises features having a dimension under 20 nm.

19. The stamp of claim 15, wherein the stamping pattern comprises features having a dimension under 10 nm.

20. The stamp of claims 15, wherein the stamping pattern comprises a plurality of distinct features.

21. The stamp of claim 20, wherein the minimum pitch between the distinct features of the stamping pattern is less than 20 nm.

22. The stamp of claim 20, wherein the minimum pitch between the distinct features of the stamping pattern is less than 10 nm.

23. The stamp of claim 21, wherein at least one of the distinct features has its dimensions under 20 nm.

24. The stamp of claim 21, wherein at least one of the distinct features has a minimum dimension under 10 nm.

25. The stamp of claim 15, wherein a diameter of the stamping pattern is greater than 1 micrometre, for example greater than 1 millimetre.
